(19) United States
(12) Patent Application Publication
(10) Pub. No.: US 2024/0386595 A1
(43) Pub. Date: Nov. 21, 2024

(54) METHOD OF ESTIMATING AT LEAST ONE DIMENSION OF AN OBJECT REPRESENTED BY A POINT CLOUD

(71) Applicant: Orange, Issy-les-Moulineaux (FR)

(72) Inventors: Olivier HOTEL, CHATILLON CEDEX (FR); Franck ROUDET, CHATILLON CEDEX (FR); David EXCOFFIER, CHATILLON CEDEX (FR)

(21) Appl. No.: 18/664,895

(22) Filed: May 15, 2024

(30) Foreign Application Priority Data
May 16, 2023 (FR) 2304867

(51) Int. Cl. G06T 7/60; G06T 7/55

(52) U.S. Cl. CPC G06T 7/60; G06T 7/55; G06T 2207/10016; G06T 2207/10028

(57) ABSTRACT

A method is described of estimating at least one dimension of an object represented by a point cloud relating to a scene comprising the object. The estimation takes into account a distance, of at least one of the points of the point cloud, from a center of the point cloud in at least one direction.

### TECHNICAL FIELD

The present disclosure relates to a method and device to estimate the dimensions of an object represented by a point cloud, such as a 3-dimensional point cloud, and can find application in numerous spheres such as computer vision for example and is applicable to several kinds of object detection.

### DISCUSSION OF RELATED TECHNOLOGY

There are several methods for estimating the size of objects from a representation in the form of a point cloud. For example, methods derived from the sector of data analysis and/or artificial intelligence propose constructing models of functions f, g, h: H=f(h), W=g(w) and D=h(d) to estimate width W, height H and depth D of objects in metres, using these same magnitudes w, h and d in pixels. These can be linear models or neural networks. Other approaches use deep neural networks to determine the pixels belonging to the contour of an object and to obtain the dimensions of the object by calculating the Euclidian distance between the points of the contour. However, said approaches are complex and necessitate a database of labelled data to determine the parameters of the different models. In addition, the execution of neural networks requires specific architectures (GPU or TPU) to perform real-time inference and perfect clipping of the object of which the dimensions are to be estimated.

There is therefore a need to propose simple solutions for estimating the dimensions of an object.

### SUMMARY

For this purpose, the disclosed technology proposes a method of estimating at least one dimension of an object represented by a point cloud relating to a scene comprising said object, wherein said estimation takes into account a distance, of at least one of said points of said point cloud, from a centre of said point cloud in said at least one direction.

In at least one embodiment, the method comprises:
obtaining said distances, in at least one direction, of said points of said point cloud from a centre of said point cloud, in said at least one direction,
sequencing said points as a function of said distances obtained.

In at least one embodiment, the method comprises:
detecting a variation in distance greater than a first value between two successive points of said sequenced points;
said estimation taking into account the distance obtained for one of said two successive points.

In at least one embodiment, sequencing of the points is performed in increasing order of said distances obtained, and said estimation of said dimension of said object, in said at least one direction, takes into account the shortest distance obtained among the distances obtained for said two points.

In at least one embodiment, the sequencing of the points is performed in decreasing order of said distances obtained, and said estimation of said dimension of said object, in said at least one direction, takes into account the longest distance obtained among the distances obtained for said two points.

In at least one embodiment, the coordinate of said centre of the point cloud in one dimension is obtained as being the median of the coordinates of the points of the point cloud in said dimension.

In at least one embodiment, when sequencing of the points is performed in

increasing order of said distances obtained, the estimated dimension is twice the distance, from the centre of the cloud, of the point in said sequence preceding the first point having a distance greater than a first value.

In at least one embodiment, when sequencing of the points is performed in decreasing order of said distances obtained, the estimated dimension is twice the distance, from the centre of the cloud, of the point in said sequence following after the first point having a distance greater than a first value.

In at least one embodiment, said method comprises normalization of said distances obtained.

In at least one embodiment, the estimation comprises:
representation of the normalized distances of the points of said point cloud, the index of said points being normalized,
determination of a distance between said representation and the curve y=x within a space of said representation, and wherein the estimated dimension is twice the distance between said centre and the point for which the distance between the representation and curve y=x is maximal.

In at least one embodiment:
the estimated dimension is compared with a value function of a measurement noise;
if said estimated value is lower than said value function of said measurement noise, then the estimated dimension is equal to twice the distance between the furthermost point from the centre and said centre.

In at least one embodiment:
said dimension is estimated in three directions corresponding to the width, depth and height of said object, the three estimated directions defining a box bounding said object.

In at least one embodiment, the method comprises:
rotation over at least two angles of said point cloud about said centre, said dimension being estimated for the at least two angles, and the method comprising a selection of the estimated dimension giving the bounding box having the smallest volume among said estimated dimensions for said at least two angles.

In at least one embodiment, said at least two angles of rotation are obtained by incrementing the angle values by a constant pitch.

In at least one embodiment, said angles of rotation are sampled following the method of Nelder-Mead.

The characteristics given alone in the present application, in connection with some embodiments of the method of the present application, can be combined together in other embodiments of the present method.

The disclosed technology also relates to a recording medium readable by a computer on which there is recorded a computer programme comprising instructions for executing the steps of the method of estimating at least one dimension of an object represented by a point cloud relating to a scene comprising said object, wherein said estimation takes into account a distance, of at least one of said points of said point cloud, from a centre of said point cloud in said at least one direction.

The disclosed technology also relates to a device comprising one or more processors configured together or separately to execute the steps of the method of the disclosed technology, according to any of the embodiments thereof. Therefore, the disclosed technology concerns a device for estimating at least one dimension of an object represented by a point cloud and relating to a scene comprising said object, the device comprising one or more processors configured together or separately to:
estimate a dimension of said object as a function of a distance, of at least one of said points of said point cloud, from a centre of said point cloud in said at least one direction.

### BRIEF DESCRIPTION OF THE DRAWINGS

Other characteristics and advantages of the disclosed technology will become apparent from the description given below with reference to the appended drawings illustrating examples of embodiment which do not in any respect limit the disclosed technology.

FIG. 1 illustrates a system implementing some embodiments of the disclosed technology.

FIG. 2 illustrates objects each in the form of a point cloud.

FIG. 3 illustrates a method according to some embodiments of the disclosed technology.

FIG. 4a gives a representation of the distance between points of a point cloud and the centre of the cloud.

FIG. 4b gives a normalized representation of the distance between points of a point cloud and the centre of the cloud.

FIG. 5 illustrates an example of a bounding box.

FIG. 6 illustrates an example of bounding boxes at two angles of rotation.

FIG. 7a illustrates an example of a point cloud without rotation.

FIG. 7b illustrates a rotation of the point cloud in FIG. 7a.

### DETAILED DESCRIPTION

The present disclosure concerns the estimation of one or more dimensions of at least one object in a scene, such as a scene captured by a digital image, this object being represented by a point cloud. A scene can represent an indoor environment or outdoor environment and may comprise one or more inert objects, animals, persons, a background . . . . By object in the disclosed technology, it can be meant an everyday object, part of said object, but also a living being such as a person or animal, a plant, or any other element captured in an image. By scene, it can be meant a scene representing a virtual image or real image.

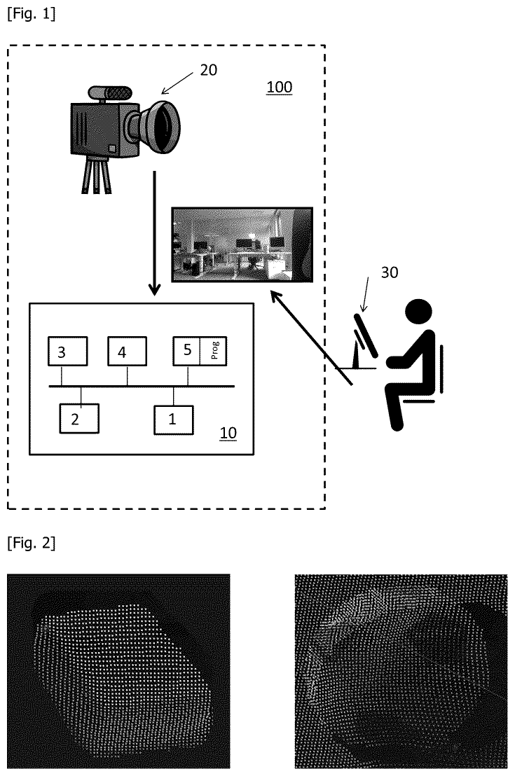

FIG. 1 illustrates a system able to implement at least some embodiments of the present disclosure.

In the example in FIG. 1, a scene is captured by capture means 20. These capture means can be of different forms and in particular can be composed of:
one or more cameras such as stereo cameras and/or LIDAR cameras (LIght Detection And Ranging»), and/or RADAR cameras (RAdio Detection And Ranging»), and/or light field cameras and/or sensors using ultrasound known as ToF sensors (Time of Flight).

These capture means can be associated with processing means 10. The processing means 10 and capture means 20 can be included in one same single device 100 or can belong to different devices coupled together. The processing means particularly comprise means allowing a point cloud to be obtained of at least one portion of the scene in the image captured by the capture means. The processing means in this respect may comprise stereo vision, Radar vision, Lidar vision devices and/or devices of ToF type.

As illustrated in FIG. 1, the processing means can have the material architecture of a computer. For example the processing means 10 particularly comprise a processor 1, RAM memory 2, ROM memory 3 and a non-volatile memory 4. They also comprise communication means 5 e.g. to communicate with the capture device 20 and/or user interface 30.

The ROM memory 3 forms a recording medium conforming to at least one embodiment of the present disclosure, readable by the processor 1 and on which a computer programme PROG is recorded conforming to at least one embodiment of the present disclosure, comprising instructions to execute steps of the method of estimating at least one dimension of at least one object according to at least one embodiment of the present disclosure. The programme PROG defines functional modules of the device.

The user interface 30 can enable a user to interact with the system, for example in some embodiments with the capture means and/or processing means. This interaction with the capture and/or processing means can be optional in some embodiments. The user interface can be in several forms, in particular one or more screens, whether or not touch screens, one or more keyboards or stylus pens or tablet, mobile telephone or computer. In FIG. 1, the user has selected an area bounding an object of which the dimensions are to be estimated by the present disclosure.

The images obtained by the capture means are for example images representing scenes captured in the form of a point cloud as illustrated in FIG. 2. FIG. 2, as an example, illustrates images obtained by the capture means representing a box and a football of which it is desired to measure the dimensions. These objects are present in a scene captured by the capture means. It is assumed for simplification that clipping of the objects in the scene, of which the dimensions are to be estimated with the method of the present application, was previously carried out to distinguish (isolate) with some accuracy the points of the point cloud (representing the object) from other points representing the captured scene (e.g. other points of a detected or designated region of interest in an image). According to embodiments, this clipping can have been performed in different manners, for example following the method subject of application FR2304863 by the Applicant.

With the present disclosure, it is possible to estimate the dimension(s) of an object that has been captured by capture means, by estimating the dimension of a bounding box bounding the point cloud representing this object. In the present disclosure, it is the smallest bounding box which is sought, the dimensions of the object then being considered as the dimensions of the smallest bounding box.

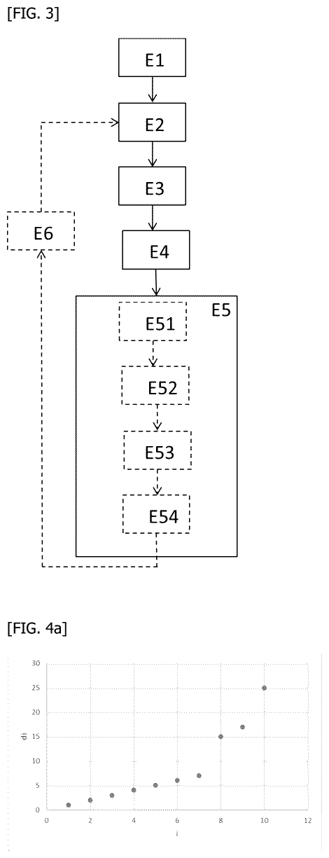

FIG. 3 illustrates one embodiment of a method according to the present disclosure.

An object in an image is considered, represented in the form of a point cloud, of which it is desired to estimate the dimension.

In the present example, the point cloud has three dimensions (x,y,z) but the disclosed technology can apply to a point cloud of one or more dimensions. The steps of the method described below relate to the estimating of the dimension in direction x (also called herein the X-axis), and the steps are reproduced, in sequence or in parallel, for the other directions to obtain all the directions. The steps described below are adapted for determining the smallest bounding box when the object lies on the axis of the capture means and, as explained later in the description, when rotation of the point cloud is envisaged in order to obtain the smallest bounding box.

At step E1, it is possible to determine the position of the centre of the point cloud and hence the coordinates thereof in the direction under consideration. According to embodiments, it is possible to obtain or determine the position of the centre of the point cloud (and hence the coordinates thereof) using different methods. For example, the coordinates of the centre in one direction can be determined as being the median of the coordinates of the points in this direction. Use of the median can make the method more robust in the face of measurement errors and outlier values which could be returned by the method.

The coordinates of the points of the cloud in the direction under consideration are obtained by the capture means e.g. a Lidar. At step E2, the distances dᵢ are calculated between point Pᵢ and the centre C in direction x.

For a point Pᵢ, the distance dᵢ obtained is the norm.

$${d}_{i} = \vert {x}_{i} - {c}_{x} \vert$$

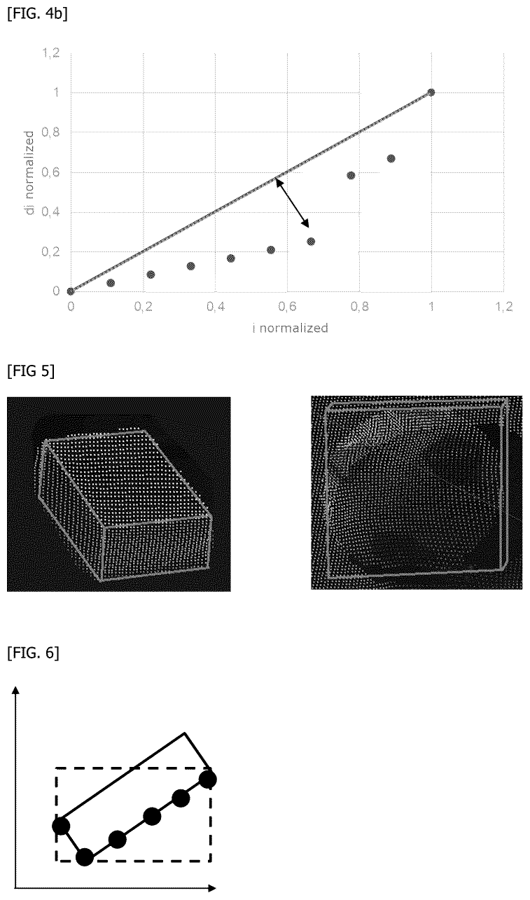

At step E3, the points Pᵢ are sequenced (or in other words sorted or classified) as a function of their distance dᵢ with coordinate Cₓ from the centre, for example according to a distance dᵢ increasing with coordinate Cₓ from the centre. FIG. 4a gives a representation after said sorting.

In other embodiments, the points Pᵢ are sequenced as a function of their distance dᵢ with coordinate Cₓ from the centre, for example according to a distance dᵢ decreasing with coordinate Cₓ from the centre.

The curve in FIG. 4a indicates that the points of indices 1 to 7 on the X-axis form a first group, and that there is a break between the point of index 7 and the point of index 8. Therefore, in the present disclosure, at E4, a variation is detected in the distance between two successive points of the sequenced points that is greater than a first value (serving as threshold). At step E5, the dimension is estimated in the at least one direction from a representation of the points taking into account the distance obtained for one of said two successive points.

When sequencing of the points is performed in increasing order of the distances obtained, the estimation of the dimension of the object, in the at least one direction, takes into account the shortest distance obtained among the distances obtained for the two points.

When sequencing of the points is performed in decreasing order of the distances obtained, the estimation of the dimension of the object, in the at least one direction, takes into account the longest distance obtained among the distances obtained for the two points.

In at least one embodiment, the dimension is estimated as being twice the distance (from the centre of the cloud) associated with the point preceding the first point having a distance greater than the first value, when the points are sorted in increasing order of distance.

In at least one embodiment, the dimension is estimated as being twice the distance associated with the point following after the first point having a distance greater than the first value, when the points are sorted in decreasing order of distance.

This first value, as illustrated in FIG. 4a, corresponds to a break in the point cloud and therefore to a limit of the object under consideration.

This first value, for example, can be a threshold value defined as a function of the mean spacing between the distances of the points having an index lower than i. For example, if it is detected that the difference between the distance associated with a point i and the distance associated with a point i+1 is greater for example than 1.5. times this mean spacing, then a break is detected.

In at least one other embodiment, to determine this break, it is also possible to determine the differences in distance between two adjacent points, one by one, and to select the point i that has a maximum difference in distance with point i+1. The dimension of the object is obtained as being twice the distance dᵢ of said point i. Hereafter, point i is called the break point.

In some embodiments, at a step E51, the curve in FIG. 4a is normalized to obtain the curve in FIG. 4b. The curves in FIGS. 4a and 4b, for the points of the point cloud, represent a distance to the centre. FIG. 4b gives the curve of FIG. 4a after normalization as explained below, and the curve of equation y=x.

i being an integer higher than or equal to 1, it is written:
m=min (dᵢ)
M=max (dᵢ)

With min (dᵢ) and max (dᵢ) respectively being the minimum and maximum values of distance dᵢ.

The X-axis of the normalized curve is:

$$x = \frac{i - 1}{N - 1}$$

### and the Y-axis:

$$y = \frac{{d}_{i} - m}{M - m}$$

Within the space of this normalized representation of the distance dᵢ of points i, the straight line is plotted of the equation y=x, step E52, as illustrated in FIG. 4b.

Estimation of the distance, according to the dimension under consideration, may then comprise a step E53 to determine, for points i, a distance between the normalized representation thereof and the ordinate thereof on the curve y=x within the representational space.

The point on the normalized curve is determined that has a maximum distance between the ordinate thereof on the normalized curve and ordinate thereof on the curve y=X.

The dimension in the direction under consideration can then be estimated as being twice the distance between the centre and the break point, i.e. the point having the maximum distance between the ordinate thereof on the normalized curve and the ordinate thereof on the curve y=x. Here, as indicated in FIG. 4b, it can be seen that this distance is the distance associated with the point of index 7, as previously in FIG. 4a.

If the index of the break point is denoted r, in the above example, r equals 7, then the dimension in the direction under consideration is equal to 2dᵣ.

In some embodiments, this estimation can be made further robust by comparing the value M previously defined with a determined value, called noise value, at step E54. The so-called noise value is determined as a function of a measurement noise of a capture device capturing an image of the point cloud. If M is higher than this measurement noise value (or threshold), then the dimension is equal to 2dᵣ otherwise the dimension is equal to 2M. This can advantageously allow overcoming of interference noise. The threshold value can be a function of the accuracy of the device capturing the point cloud. For some capture devices, it can be in the region of a few millimetres to a few tens of millimetres. For example, if a LIDAR has an accuracy of +/−2 mm, then any difference of this magnitude does not correspond to a break but to noise. This measurement noise can be filtered by only giving consideration to breaks that are greater than this noise.

The steps of the method can be repeated or performed in parallel for at least one other dimension of the object, for example for the two other directions y and z in the detailed examples.

It is therefore possible to estimate the dimension in three dimensions corresponding to the width, depth and height, the three estimated dimensions defining a box bounding the region of interest as illustrated in FIG. 5.

In some embodiments, the preceding steps can be iterated to check that the box obtained is the smallest box bounding the region of interest, as illustrated in FIG. 6. The steps of the method, such as previously described, allow the obtaining of the smallest bounding box when the object lies on the axis of the image capturing means. However, when this is not the case, it is possible to carry out one or more rotations of the point cloud and to reiterate the previously described steps to obtain the smallest bounding box.

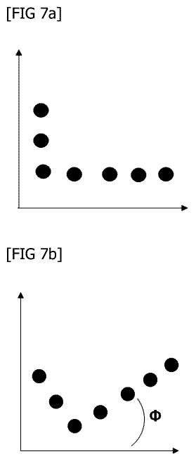

In FIG. 6, the dotted box does not represent the smallest bounding box, it is the box in solid lines which represents the smallest bounding box. At the time of iterations, rotation of the point cloud over a plurality of angles can be carried out, each new iteration corresponding for example to a different angle as indicated in FIGS. 7a and 7b. Rotation can be performed in at least one of the directions under consideration (e.g. in each of these directions) at an angle Φₓ, Φ_{y}, Φ_{z} in each of the directions. Therefore step E6 can be a step to rotate the point cloud.

In some embodiments, rotation can be performed by incrementing the angle values by a constant or variable pitch.

In some embodiments, the chosen angles for each iteration are sampled using an optimization algorithm. For example, among the optimization algorithms used, it can be envisaged to use the Nelder-Mead method for performing rotation of the point cloud. The Nelder-Mead method allows the determining of parameters minimizing a certain criterion. In our case, the parameters are the rotation angles for example of the point cloud, and the criterion is for example the volume of the bounding box.

This can help towards limiting the number of necessary iterations to determine the optimal angles (i.e. minimizing the size of the bounding box) and hence the dimensions of the bounding box corresponding to the object, and thereby obtain the dimensions (and hence size) of the point cloud of the object.

One application of this disclosure can particularly find advantage in the manufacturing industry, for example for verification of the conformity of a part produced on a production line. By allowing estimation of some dimensions of a part (e.g. a part detected more or less automatically, for example with the method described in the previously cited patent application by the Applicant), the present disclosure can help towards verifying the shape and/or size of a product and/or whether it conforms to an expected result or to specifications, this being at least partially automatic (e.g. without human intervention). The obtaining of better knowledge of the size (and optionally location) of objects handled by robots can also help towards making robot movements more stable and more precise.

Other applications can concern the logistics sector. The embodiments described in this disclosure can be used to locate goods in warehouses. Knowledge of the size of objects can help toward limiting the storage space required for storing goods, and toward management of flows of goods in warehouses, by optimizing warehousing thereof e.g. in containers.

Other applications can concern the automated driving of vehicles. Estimating the dimensions of obstacles (other vehicles, objects, roadworks . . . ) on the roadway can help toward choosing the autopilot response to be given to the presence of the latter (deviation from trajectory, emergency stop of the vehicle, etc.).

Other applications can concern environmental mapping to allow the navigation of robots, drones and automated vehicles in the presence of obstacles.

1) A method of estimating at least one dimension of an object, said object represented by a point cloud relating to a scene comprising said object, said estimating comprising:
taking into account a distance, of at least one point of a plurality of points of said point cloud, from a center of said point cloud in at least one direction.

2) The method of claim 1, further comprising:
obtaining, for said plurality of points of said point cloud, distances from a center of said point cloud in said at least one direction; and
sequencing said plurality of points as a function of said distances obtained.

3) The method of claim 2, further comprising:
detecting a variation in distance greater than a first value between two successive points of said sequenced points, said estimation taking into account the distance obtained for one of said two successive points.

4) The method of claim 3, wherein the sequencing of the plurality of points is performed in increasing order of said distances obtained, and said estimation of said dimension of said object, in said at least one direction, takes into account a shortest distance obtained among the distances obtained for said two successive points.

5) The method of claim 3, wherein the sequencing of the plurality of points is performed in decreasing order of said distances obtained, and said estimation of said dimension of said object, in said at least one direction, takes into account a longest distance obtained among the distances obtained for said two successive points.

6) The method of claim 1, wherein a coordinate of said center of the point cloud in a dimension is obtained as being a median of coordinates of the plurality of points of the point cloud in said dimension.

7) The method of claim 4 wherein, when the sequencing of the plurality of points is performed in increasing order of said distances obtained, the estimated dimension is twice a distance, from the center of the cloud, of a point in said sequence preceding the first point having a distance greater than a first value.

8) The method of claim 5 wherein, when the sequencing of the plurality of points is performed in decreasing order of said distances obtained, the estimated dimension is twice a distance, from the center of the cloud, of a point in said sequence following after the first point having a distance greater than a first value.

9) The method of claim 2, wherein said method further comprises normalization of said distances obtained.

10) The method of claim 9, wherein the estimation of the at least one dimension of an object further comprises:
representing the normalized distances of the points of said point cloud, the index of said points being normalized; and
determining a distance between said representation and a curve y=x within a space of said representation, wherein the estimated dimension is twice a distance between said center and a point for which the distance between the representation and the curve y=x is maximal.

11) The method of claim 1, wherein:
the estimated dimension is compared with a value function of a measurement noise; and
when said estimated value is lower than said value function of said measurement noise, the estimated dimension is equal to twice a distance between the point the furthest distant from the center and said center.

12) The method of claim 1, wherein the dimension of the object is estimated in three directions corresponding to a width, depth and height of said object, the three estimated directions defining a box bounding said object.

13) The method of claim 12, further comprising a rotation over at least two angles of said point cloud about said centre, said dimension being estimated for the at least two angles, and the method comprising the selecting of the estimated dimension giving the bounding box having the smallest volume, from among said estimated dimensions for said at least two angles.

14) The method of claim 13, wherein said at least two angles of rotation are obtained by incrementing values of the angles by a constant pitch.

15) A recording medium readable by a computer on which there is recorded a computer program comprising instructions to execute the steps of a method of estimating at least one dimension of an object, said object represented by a point cloud relating to a scene comprising said object, said estimation comprising taking into account a distance, of at least one point of a plurality of points of said point cloud, from a center of said point cloud in at least one direction.

16) A device to estimate at least one dimension of an object, said object represented by a point cloud relating to a scene comprising said object, the device comprising one or more processors configured together or separately to:
estimate a dimension of said object as a function of a distance, of at least one point of a plurality of points of said point cloud, from a center of said point cloud in at least one direction.
